(19) United States
(12) Patent Application Publication
(10) Pub. No.: US 2007/0081442 A1
(43) Pub. Date: Apr. 12, 2007

(54) Method and apparatus for modulating data in optical disk recording/reproducing apparatus

(75) Inventor: Eun-Jin Choi, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/543,840

(22) Filed: Oct. 6, 2006

(30) Foreign Application Priority Data
Oct. 6, 2005 (KR) 10-2005-0093901

(51) Int. Cl. G11B 7/00

(52) U.S. Cl. 369/124.04

(57) ABSTRACT

Provided are a method and apparatus for modulating data in an optical disk recording/reproducing apparatus. The method of modulating data may include modulating source data by using a modulation table including a plurality of modulation rows, wherein each of the plurality of modulation rows may include a plurality of modulation code word bits illustrating a modulation code word, digital sum value (DSV) position bits illustrating a position of a DSV control bit and a row selection bit determining whether each of the modulation rows corresponds to an odd data word of the source data or an even data word of the source data. The method and apparatus may be used for modulating data so that data modulation speed may be increased. The size of a memory storing the modulation table in the optical disk recording/reproducing apparatus may be reduced.

### PRIORITY STATEMENT

This application claims priority under 35 USC § 119 to Korean Patent Application No. 10-2005-0093901, filed on Oct. 06, 2005, in the Korean Intellectual Property Office (KIPO), the entire contents of which are incorporated herein reference.

### BACKGROUND

1. Field

Example embodiments relate to an optical disk recording/reproducing apparatus. Other example embodiments relate to a method and apparatus for modulating data in an optical disk recording/reproducing apparatus, in which data modulation may be performed using a reduced size modulation table.

2. Description of the Related Art

Optical disk recording/reproducing apparatuses may have a data modulation function that modulates and outputs source data. In optical disk recording/reproducing apparatuses, data modulation may be performed by searching and mapping data words, which correspond to source data that is to be modulated, and the current state in a modulation table. Data word of source data, code word corresponding to the current state, and the next state may be searched in the modulation table and may be mapped in order to modulate the source data.

Conventional modulation tables include sub-tables according to the current state. Each of the sub-tables may include a plurality of modulation rows.

FIG. 1 illustrates a drawing of a modulation row in a conventional modulation table used in a conventional method of modulating data. Referring to FIG. 1, the modulation row 100 in the conventional modulation table may be formed of source code word bits 110 and a next state 120. Generally, the source code word bits 110 may be 12 bits and the next state 120 may be 2 bits.

Table 1A and Table 1B may be each a part of the conventional modulation table.

TABLE 1A

| | State 0 | | | State 1 | | | State 2 | | |
|---|---|---|---|---|---|---|---|---|---|
| Data | | | Next | | | Next | | | Next |
| Word | Code Word | | State | Code Word | | State | Code Word | | State |
| 00 | 100010 | 00000* | 0 | 010100 | 01000* | 0 | 010100 | 01000* | 0 |
| 01 | 100010 | 00000# | 1 | 010100 | 010001 | 1 | 010100 | 010001 | 1 |
| 02 | 100010 | 000010 | 0 | 010100 | 010010 | 0 | 010100 | 010010 | 0 |
| 03 | 100010 | 000010 | 1 | 010100 | 010010 | 1 | 010100 | 010010 | 1 |
| 04 | 100010 | 10000* | 0 | 010100 | 01010* | 0 | 010100 | 01010* | 0 |
| 05 | 100010 | 10000# | 1 | 010100 | 010101 | 1 | 010100 | 010101 | 1 |
| 06 | 100010 | 100010 | 0 | 010100 | 010100 | 2 | 010100 | 010100 | 2 |
| 07 | 100010 | 100010 | 1 | 010100 | 010000 | 2 | 010100 | 010000 | 2 |
| 08 | 100010 | 10100* | 0 | 010100 | 00#00* | 0 | 010100 | 00#00* | 0 |
| 09 | 100010 | 101001 | 1 | 010100 | 00#001 | 1 | 010100 | 00#001 | 1 |
| 0A | 100010 | 101010 | 0 | 010100 | 00#010 | 0 | 010100 | 00#010 | 0 |
| 0B | 100010 | 101010 | 1 | 010100 | 00#010 | 1 | 010100 | 00#010 | 1 |
| 0C | 100010 | 10010* | 0 | 010100 | 00010* | 0 | 010100 | 00010* | 0 |
| 0D | 100010 | 100101 | 1 | 010100 | 000101 | 1 | 010100 | 000101 | 1 |
| 0E | 100010 | 100100 | 2 | 010100 | 000100 | 2 | 010100 | 000100 | 2 |
| 0F | 100010 | 101000 | 2 | 010100 | 001000 | 2 | 010100 | 001000 | 2 |
| 10 | 100010 | 01000* | 0 | 010000 | 01000* | 0 | 010000 | 01000* | 0 |
| 11 | 100010 | 010001 | 1 | 010000 | 010001 | 1 | 010000 | 010001 | 1 |
| 12 | 100010 | 010010 | 0 | 010000 | 010010 | 0 | 010000 | 010010 | 0 |
| 13 | 100010 | 010010 | 1 | 010000 | 010010 | 1 | 010000 | 010010 | 1 |

TABLE 1B

| | State 0 | | | State 1 | | | State 2 | | |
|---|---|---|---|---|---|---|---|---|---|
| Data | | | Next | | | Next | | | Next |
| Word | Code Word | | State | Code Word | | State | Code Word | | State |
| BC | 100101 | 00010* | 0 | 000101 | 00010* | 0 | 000101 | 00010* | 0 |
| BD | 100101 | 000101 | 1 | 000101 | 000101 | 1 | 000101 | 000101 | 1 |
| BE | 100101 | 000100 | 2 | 000101 | 000100 | 2 | 000101 | 000100 | 2 |
| BF | 100101 | 001000 | 2 | 000101 | 001000 | 2 | 000101 | 001000 | 2 |
| C0 | 000010 | 00000* | 0 | 001010 | 00000* | 0 | 00#010 | 00000* | 0 |
| C1 | 000010 | 00000# | 1 | 001010 | 00000# | 1 | 00#010 | 00000# | 1 |
| C2 | 000010 | 000010 | 0 | 001010 | 000010 | 0 | 00#010 | 000010 | 0 |
| C3 | 000010 | 000010 | 1 | 001010 | 000010 | 1 | 00#010 | 000010 | 1 |
| C4 | 000010 | 10000* | 0 | 001010 | 10000* | 0 | 00#010 | 10000* | 0 |
| C5 | 000010 | 10000# | 1 | 001010 | 10000# | 1 | 00#010 | 10000# | 1 |
| C6 | 000010 | 100010 | 0 | 001010 | 100010 | 0 | 00#010 | 100010 | 0 |
| C7 | 000010 | 100010 | 1 | 001010 | 100010 | 1 | 00#010 | 100010 | 1 |
| C8 | 000010 | 10100* | 0 | 001010 | 10100* | 0 | 00#010 | 10100* | 0 |
| C9 | 000010 | 101001 | 1 | 001010 | 101001 | 1 | 00#010 | 101001 | 1 |
| CA | 000010 | 101010 | 0 | 001000 | 000010 | 0 | 001000 | 000010 | 0 |
| CB | 000010 | 101010 | 1 | 001010 | 101010 | 1 | 00#010 | 101010 | 1 |
| CC | 000010 | 10010* | 0 | 001010 | 10010* | 0 | 00#010 | 10010* | 0 |
| CD | 000010 | 100101 | 1 | 001010 | 100101 | 1 | 00#010 | 100101 | 1 |
| CE | 000010 | 100100 | 2 | 001010 | 100100 | 2 | 00#010 | 100100 | 2 |
| CF | 000010 | 101000 | 2 | 001010 | 101000 | 2 | 00#010 | 101000 | 2 |

Referring to Tables 1A and 1B, code words and next states in even data word rows and odd data word rows may be almost the same except for a few bits. The code words in the even data word rows and odd data word rows may be the same except for merging bits * and digital sum value (DSV) control bits #. Except for the data word rows having the next states as 2, the next states in the even data word rows may be 0 and the next states in the odd data word rows may be 1.

The code words and next states in a state 1 sub-table and a state 2 sub-table may be the same except for a few bits. The code words and the next states in the state 1 sub-table and the state 2 sub-table may be the same except that in the state 2 sub-table, the code words in the data word rows having the data word greater than C0 include DSV control bits #.

As described, in the conventional modulation table, the code words and next states may overlap. When source data is modulated using the conventional modulation table, it may take a relatively long time to search the conventional modulation table and thus the data modulation speed may be decreased. An apparatus for modulating data in an optical disk recording/reproducing apparatus using the conventional modulation table may need to store all overlapping data of the conventional modulation table. The size of a memory storing the conventional modulation table may be relatively large.

### SUMMARY

Example embodiments provide a method of modulating data in an optical disk recording/reproducing apparatus that performs data modulation using a reduced size modulation table. Example embodiments also provide an apparatus for modulating data in an optical disk recording/reproducing apparatus that performs data modulation using a reduced size modulation table.

According to example embodiments, a method of modulating data in an optical disk recording/reproducing apparatus may include modulating source data by using a modulation table including a plurality of modulation rows, wherein each of the plurality of modulation rows may include a plurality of modulation code word bits illustrating a modulation code word, digital sum value (DSV) position bits illustrating a position of a DSV control bit and a row selection bit determining whether each of the modulation rows of the modulation table corresponds to an odd data word of the source data or an even data word of the source data.

The modulation table may include a plurality of sub-tables corresponding to a current state of the source data, wherein each of the plurality of sub-tables may include the plurality of modulation rows corresponding to the current state. The sub-tables may be classified as first sub-tables when the current state of the source data is 0 and second sub-tables when the current state of the source data may be 1 or 2.

The modulation rows may each correspond to the current state of the source data and the data word. The modulating of the source data may include outputting the modulation row corresponding to the data word and the current state of the source data from the modulation table and outputting the final code word and the next state in response to the modulation row.

The outputting of the next state may output the next state as 2 when the lowest 2 bits of the modulation code word of the modulation row is 00, output the next state as 0 when the lowest bit of the data word of the source data may be 0, and output the next state as 1 when the lowest bit of the data word of the source data may be 1.

The outputting of the final code word may include determining whether the next state of the modulation row is 2 and the value of the data word of the source data is an odd number, determining whether a merging bit exists in response to the data word of the source data and determining whether the DSV control bit exists in response to the DSV position bits of the modulation row and the position of the DSV control bit.

According to other example embodiments, a memory unit may include a modulation table further including a plurality of modulation rows, each of the plurality of modulation rows further including a plurality of modulation code word bits indicating a modulation code word, digital sum value (DSV) position bits indicating a position of DSV control bit, and a row selection bit indicating whether each of the modulation rows corresponds to an odd data word of source data or an even data word of the source data.

According to other example embodiments, an apparatus for modulating data, which modulates source data, in an optical disk recording/reproducing apparatus may include a memory unit that stores a modulation table including a plurality of modulation rows, wherein each of the plurality of modulation rows may include a plurality of modulation code word bits illustrating a modulation code word, digital sum value (DSV) position bits illustrating a position of DSV control bit and row selection bit determining whether each of the modulation rows corresponds to an odd data word of the source data or an even data word of the source data and a modulator that outputs modulation data by modulating the source data using the modulation table.

The modulator may output a final code word and a next state in response to the data word and a current state of the source data from the modulation table and modulate the source data using the final code word and the next state. The modulator may include a modulation control unit that outputs the modulation row corresponding to the data word and the current state of the source data from the modulation table and outputs the final code word and the next state in response to the modulation row and a modulation data output unit that outputs modulation data by modulating the source data in response to the final code word and the next state.

The modulation control unit may include a next state determining logic that outputs the next state in response to the modulation code word of the modulation row and the data word of the source data and a final code word determining logic that outputs the final code word in response to the next state and the modulation row.

The optical disk recording/reproducing apparatus may be a HD-DVD.

### BRIEF DESCRIPTION OF THE DRAWINGS

Example embodiments will be more clearly understood from the following detailed description taken in conjunction with the accompanying drawings. FIGS. 1-5 represent non-limiting, example embodiments as described herein.

FIG. 1 illustrates a drawing of a modulation row in a conventional modulation table used in a conventional method of modulating data;

FIG. 2 illustrates a drawing of a modulation row in a modulation table used in a method of modulating data according to example embodiments;

FIG. 3 illustrates a flowchart of operations of determining a next state in a method of modulating data according to example embodiments;

FIG. 4 illustrates a flowchart of operations of determining a final code word in a method of modulating data according to example embodiments; and

FIG. 5 illustrates a block diagram of an apparatus for modulating data according to example embodiments.

### DETAILED DESCRIPTION OF EXAMPLE EMBODIMENTS

Hereinafter, example embodiments will be described more fully with reference to the accompanying drawings, in which example embodiments are shown. In the drawings, like reference numerals denote like elements, and the sizes and thicknesses of layers and regions are exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below.” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements and/or components, but do not preclude the presence or addition of one or more other features, integers, steps, operations, elements, components and/or groups thereof.

Example embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Table 2A and Table 2B may be each a part of a modulation table according to example embodiments. Table 2A may correspond to Table 1A and Table 2B may correspond to Table 1B.

TABLE 2A

| | State 0 | | | | | State 1, 2 | | | | |
|---|---|---|---|---|---|---|---|---|---|---|
| | | | DSV | DSV | Row | | | DSV | DSV | Row |
| Data | Code Word | | Position | Presence | Selection | Code Word | | Position | Presence | Selection |
| Word | (MCW) | | Bits | Bit | Bit | (MCW) | | Bits | Bit | Bit |
| 0000000 | 100010 | 00000* | 00 | 1 | 0 | 010100 | 01000* | 10 | 0 | 0 |
| 0000001 | 100010 | 000010 | 10 | 0 | 0 | 010100 | 010010 | 10 | 0 | 0 |
| 0000010 | 100010 | 10000* | 00 | 1 | 0 | 010100 | 01010* | 10 | 0 | 0 |
| 0000011 | 100010 | 100010 | 10 | 0 | 0 | 010100 | 010100 | 10 | 0 | 0 |
| 0000100 | 100010 | 10100* | 10 | 0 | 0 | 010100 | 00#00* | 01 | 1 | 0 |
| 0000101 | 100010 | 101010 | 10 | 0 | 0 | 010100 | 00#010 | 01 | 1 | 0 |
| 0000110 | 100010 | 10010* | 10 | 0 | 0 | 010100 | 00010* | 10 | 0 | 0 |
| 0000111 | 100010 | 100100 | 10 | 0 | 0 | 010100 | 000100 | 10 | 0 | 0 |
| 0001000 | 100010 | 01000* | 10 | 0 | 0 | 010000 | 01000* | 10 | 0 | 0 |
| 0001001 | 100010 | 010010 | 10 | 0 | 0 | 010000 | 010010 | 10 | 0 | 0 |

TABLE 2B

| | State 0 | | | | | State 1, 2 | | | | |
|---|---|---|---|---|---|---|---|---|---|---|
| | | | DSV | DSV | Row | | | DSV | DSV | Row |
| Data | Code Word | | Position | Presence | Selection | Code Word | | Position | Presence | Selection |
| Word | (MCW) | | Bits | Bit | Bit | (MCW) | | Bits | Bit | Bit |
| 1011110 | 100101 | 00000* | 10 | 0 | 0 | 000101 | 00010* | 10 | 0 | 0 |
| 1011111 | 100101 | 000100 | 10 | 0 | 0 | 000101 | 000100 | 10 | 0 | 0 |
| 1100000 | 000010 | 00000* | 00 | 1 | 0 | 001010 | 00000* | 11 | 1 | 0 |
| 1100001 | 000010 | 000010 | 10 | 0 | 0 | 001010 | 000010 | 11 | 1 | 0 |
| 1100010 | 000010 | 10000* | 00 | 1 | 0 | 001010 | 10000* | 11 | 1 | 0 |
| 1100011 | 000010 | 100010 | 10 | 0 | 0 | 001010 | 100010 | 11 | 1 | 0 |
| 1100100 | 000010 | 10100* | 10 | 0 | 0 | 001010 | 10100* | 11 | 1 | 0 |
| 1100101 | 000010 | 101010 | 10 | 0 | 0 | 001000 | 000010 | 11 | 1 | 0 |
| 1100110 | 000010 | 10010* | 10 | 0 | 0 | 001010 | 10010* | 11 | 1 | 0 |
| 1100111 | 000010 | 100100 | 10 | 0 | 0 | 001010 | 100100 | 11 | 1 | 0 |

Referring to Tables 1A and 2B, and Tables 2A and 2B, the modulation table according to example embodiments may be prepared by putting an odd data word row and an even data word row of a conventional modulation table into one modulation row. A modulation code word (MCW) in the modulation table of example embodiments may use a code word in the odd data word row or the even data word row of the conventional modulation table as is presently illustrated. The code word in the conventional modulation table may be 7 bits but the code word or the MCW in the modulation table of example embodiments may be 8 bits. Tables 2A and 2B may be prepared based on the even data word row of Tables 1A and 1 B. Tables 2A and 2B may be prepared based on the odd data word row of Tables 1A and 1B.

A state 1 sub-table and a state 2 sub-table of the conventional modulation table may be combined in the modulation table of example embodiments. The modulation table of example embodiments may include a plurality of sub-tables according to a current state of source data and each of the plurality of sub-tables may include a plurality of modulation rows. The sub-tables may be first sub-tables having the current state of source data as 0 and second sub-tables having the current state of source data as 1 or 2.

FIG. 2 illustrates a drawing of a modulation row 200 in the modulation table used in a method of modulating data according to example embodiments.

Referring to FIG. 2, the modulation table used in the method of modulating data according to example embodiments may include a plurality of modulation rows 200. Each modulation row 200 may include modulation code word bits 210, a digital sum value (DSV) position bits 220 and/or row selection bits 230. The modulation code word bits 210 may illustrate a MCW, the DSV position bits 220 may illustrate a position of the DSV control bit # and the row selection bits 230 may illustrate whether the modulation row 200 of example embodiments was prepared based on an odd data word row and/or an even data word row of a conventional modulation table. Each modulation row 200 may further include the DSV presence bit 230 illustrating whether the DSV control bit # exists.

When the DSV control bit # exists in the corresponding modulation row, the DSV presence bits 230 may be 1, and when the DSV control bit # does not exist in the corresponding modulation row, the DSV presence bits 230 may be 0. When the DSV control bit # exists on a 0 bit position of the code word (MCW), the DSV position bits 220 may have a value of 00. When the DSV control bit # exists on a 3 bit position of the code word (MCW), the DSV position bits 220 may have a value of 01. When the DSV control bit # exists on a 9 bit position of the code word (MCW), the DSV position bits 220 may have a value of 11. When the DSV control bit # does not exist on any position of the code word (MCW), the DSV position bits 220 may have a value of 00.

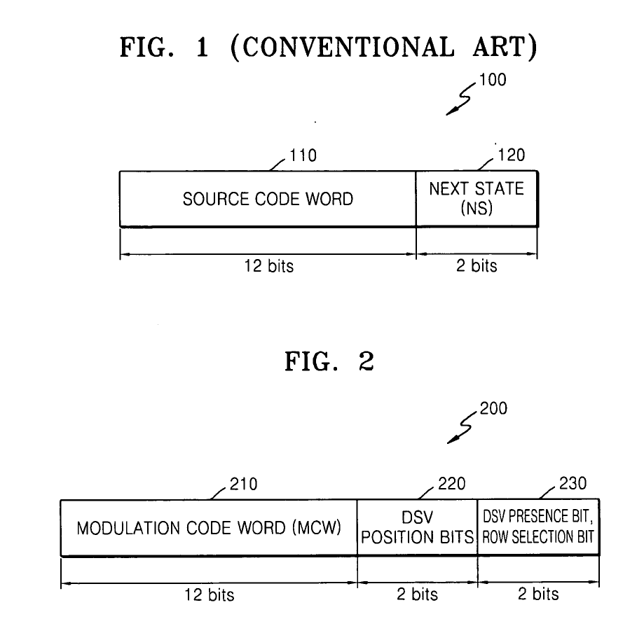

In the modulation row 200 of the modulation table according to example embodiments, the size of the DSV position bits 220 may be 2 bits, the size of the row selection bit 230 may be 1 bit and the size of the DSV presence bit 230 may be 1 bit. Hereinafter, the size of the modulation table according to example embodiments and the size of the conventional modulation table will be compared with reference to FIGS. 1 and 2, Tables 1A and 1B, and Tables 2A and 2B.

One modulation row 100 of the conventional modulation table may include the source code word bits 110 composed of 12 bits and the next state 120 composed of 2 bits. One modulation row 100 of the conventional modulation table may be composed of 14 bits. The number of sub-tables in the conventional modulation table may be 3 and the number of modulation rows in each sub-table may be 256. The size of the conventional modulation table may be 14 bits (size of a modulation row)×3 bits (number of sub-tables)×256 (number of modulation rows)=10,752 bits.

One modulation row 200 of the modulation table according to example embodiments may include the modulation code word bits 210 composed of 12 bits, the DSV position bits 220 composed of 2 bits, the row selection bit 230 composed of 1 bit and the DSV presence bit 230 composed of 1 bit. One modulation row 200 of the modulation table according to example embodiments may be composed of 16 bits. The number of sub-tables in the modulation table according to example embodiments may be 2 and the number of modulation rows in each sub-table may be 128. The size of the modulation table according to example embodiments may be 16 bits (size of a modulation row)×2 bits (number of sub-tables)×128 (number of modulation rows)=4,096 bits.

Because the conventional modulation table may be 10,752 bits and the modulation table of example embodiments may be 4,096 bits, the modulation table of example embodiments may be relatively small as compared to the conventional modulation table. The method of modulating data according to example embodiments may output a next state (NS) and a final code word (FCW) corresponding to the current state and the data word (DW) of the source data that may be to be modulated using information from the modulation table, e.g., Tables 2A and 2B. The source data may be modulated using the outputted NS and the FCW.

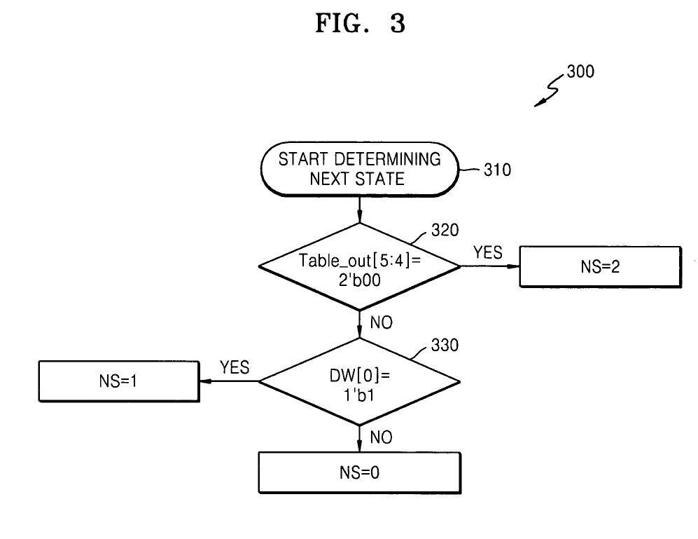

FIG. 3 illustrates a flowchart of operations of determining a NS in a method of modulating data according to example embodiments. Hereinafter, Table_out[m:n] may denote a value of the modulation row from m bit to n bit. For example, Table_out[5:4] may be a value of the last 2 bits of the MCW and Table[3:2] may be the DSV position bit. Referring to FIG. 3, in the operations of determining the NS in 300, determining the NS may be started in 310, the NS may be output as 2 in 320, when the last 2 bits (Table_out[5:4]) of the MCW may be 00. In 330, the NS may be outputted as 0 when the lowest bit (Table_out[0]) of the DW is 0, and the NS may be outputted as 1 when the lowest bit (Table_out[0]) of the DW is 1.

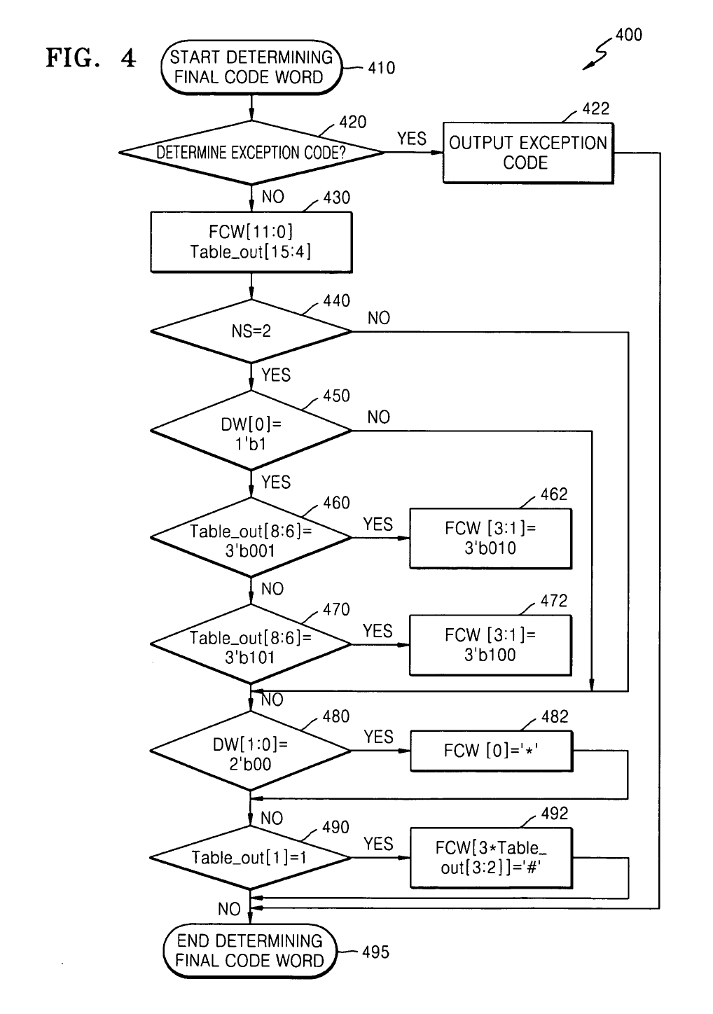

FIG. 4 illustrates a flowchart of operations of determining a FCW in a method of modulating data according to example embodiments. Referring to FIG. 4, the determining of the FCW in 400 in the method of modulating data according to example embodiments may include starting the determination of the FCW in 410 and determining whether the MCW of the modulation row is an exception code word in 420. If so, the exception code is output and flow continues to 495 to end the final code word determination. If not, the FCW [11:0] is set to Table_out[15:4] at 430. The method of modulating data may further include determining whether the NS is 2 in 440 and determining whether the DW[0]=1'b1 at 450. At 460, if Table_out[8:6]=3'b001, then FCW [3:1] is set to 3'b010 at 462.

If not, if Table_out[8:6]=3'b101 at 470, then FCW [3:1] is set to 3'b100. If not, if DW[1:0]=2'b00 at 482, then FCW [0] is set to ‘*’. If DW[1:0] is not equal to 2'b00 at 480, if Table_out[1]=1 at 490, then FCW [3*Table_out[3:2]]=‘#’.

As set forth above the method of modulating data may further include determining whether a merging bit * exists in response to the DW corresponding to the modulation row in 480 and determining whether the DSV control bit # exists in response to the DSV position bits 220, and the position of the DSV control bit #. In 482, the FCW may be outputted as 0 when the lowest bit (Table_out[0]) of the DW is 0, and the FCW may be outputted as 1 when the lowest bit (Table_out[0]) of the DW is 1.

As set forth above, when the NS is determined to be 2 and the DW of the received source data is determined to be an odd number in 440 and 450, the FCW may be outputted after changing a part of the bits of the MCW. For example, when the MCW is MCW [4:2]==3'b010, the FCW may be changed to FCW [4:2]=3'b100, and when the MCW is MCW [4:2]==3'b101, the FCW may be changed to FCW [4:2]=3'b100.

As set forth above, in 480, when the lowest 2 bits of the DW of the received source data is 0, the lowest of the lowest bits of the FCW may be outputted in the merging bit *. In 490, when the value (Table_out[1]) of the DSV presence bit 230 is 1, the DSV control bit # may be included in the FCW, and when the value (Table_out[1]) of the DSV presence bit 230 is 0, as in 492, the DSV control bit # may not be included in the FCW.

When the value (Table_out[1]) of the DSV presence bit 230 is 1, the position of the DSV control bit # may be determined using the DSV position bits in 220. Based on the FCW [3*DSV position bit]=‘#’, the FCW may be outputted while including the DSV control bit #. When the value (Table_out[3:2]) of the DSV position bits 220 may be 00, the DSV control bit # exists on 0 bit position of the FCW, for example, FCW [0]=‘#’. When the value (Table_out [3:2]) of the DSV position bits 220 is 01, the DSV control bit # exists on 3 bit position of the FCW, for example, FCW [3]=‘#’. When the value (Table_out [3:2]) of the DSV position bits 220 is 11, the DSV control bit # exists on 9 bit position of the FCW, for example, FCW [9]=‘#’. When the value (Table_out [3:2]) of the DSV position bits 220 is 10, the DSV control bit # may not be included in the FCW.

As set forth above, in 420, when the source data corresponding to the exception code word is inputted, the corresponding MCW may be determined to be the exception code word. The exception code word may be outputted as the FCW in 422, and then, 410, e.g., the determining of the FCW, may be terminated.

Table 3 shows the modulation rows including the exception code words that may be in bold letters.

TABLE 3

| | State 0 | | | State 1 | | | State 2 | | |
|---|---|---|---|---|---|---|---|---|---|
| Data | | | Next | | | Next | | | Next |
| Word | Code Word | | State | Code Word | | State | Code Word | | State |
| 48 | 000000 | 00100* | 0 | 010010 | 10100* | 0 | 010010 | 10100* | 0 |
| 49 | 100000 | 000001 | 1 | 010010 | 101001 | 1 | 010010 | 101001 | 1 |
| 4E | 101010 | 100100 | 0 | 010010 | 100100 | 0 | 010010 | 100100 | 0 |
| 4F | 000000 | 001000 | 1 | 010010 | 101000 | 1 | 010010 | 101000 | 1 |
| CA | 000010 | 101010 | 0 | 001000 | 000010 | 0 | 001000 | 000010 | 0 |
| CB | 000010 | 101010 | 1 | 001010 | 101010 | 1 | 00#010 | 101010 | 1 |

The method of modulating data according to example embodiments may further include setting an initial value to the final code word in 430. In 430, the value of the MCW (Table_out[15:4]) in the modulation table may be set as the initial value of the FCW.

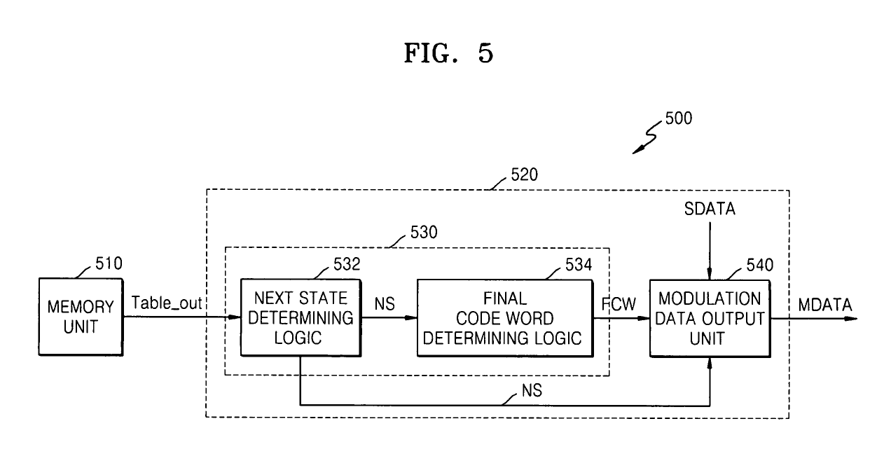

FIG. 5 illustrates a block diagram of an apparatus 500 for modulating data according to example embodiments. Referring to FIG. 5, the apparatus 500 for modulating data according to example embodiments may include a memory unit 510 and a modulator 520. The memory unit 510 may store information on a modulation table, wherein the modulation table may include a plurality of modulation rows. Each modulation row may include MCW bits, DSV position bits and/or a row selection bit. The MCW bits may illustrate a MCW, the DSV position bits may illustrate a position of a DSV control bit and the row selection bit may illustrate whether the corresponding modulation row may be an odd row and/or an even row. The modulator 520 may output modulation data (MDATA) by modulating source data (SDATA) using the information on the modulation table stored in the memory unit 510.

The modulator 520 may output a FCW and a NS in response to a data word and a current state of the SDATA from the modulation table and may modulate the SDATA using the FCW and the NS. The modulator 520 may include a modulation control unit 530 and a modulation data output unit 540. The modulation control unit 530 may output the modulation row corresponding to the data word and the current state of the SDATA from the modulation table and may output the FCW and the NS in response to the modulation row. The modulation data output unit 540 may modulate the source data SDATA in response to the NS and the FCW and may output the MDATA.

The modulation control unit 530 may include a next state determining logic 532 and a final code word determining logic 534. The next state determining logic 532 may output the NS of the SDATA in response to the MCW and the row selection bit of the modulation row. The final code word determining logic 534 may output the FCW of the SDATA in response to the NS and the modulation row. The optical disk recording/reproducing apparatus including the apparatus 500 for modulation data may be an HD-DVD.

Using the method and apparatus for modulating data according to example embodiments in the optical disk recording/reproducing apparatus, data modulation speed may be increased. The size of a memory storing the modulation table in the optical disk recording/reproducing apparatus may be reduced.

While example embodiments have been particularly shown and described with reference to example embodiments thereof, it will be understood by those of ordinary skill in the art that various changes in form and details may be made therein without departing from the spirit and scope of the following claims.

What is claimed is:

1. A method of modulating data in an optical disk recording/reproducing apparatus, the method comprising:
modulating source data using a modulation table including a plurality of modulation rows, wherein each of the plurality of modulation rows includes a plurality of modulation code word bits illustrating a modulation code word, digital sum value (DSV) position bits illustrating a position of a DSV control bit, and a row selection bit determining whether each of the modulation rows of the modulation table corresponds to an odd data word of the source data or an even data word of the source data.

2. The method of claim 1, wherein the modulation table includes a plurality of sub-tables corresponding to a current state of the source data, wherein each of the plurality of sub-tables includes the plurality of modulation rows corresponding to the current state.

3. The method of claim 2, wherein the sub-tables are classified as first sub-tables when the current state of the source data is 0 and second sub-tables when the current state of the source data is 1 or 2.

4. The method of claim 1, wherein the modulation rows each correspond to the current state of the source data and the data word.

5. The method of claim 1, wherein modulating the source data is performed by outputting a final code word and a next state in response to the data word and the current state of the source data from the modulation table.

6. The method of claim 5, wherein modulating the source data further includes:
outputting the modulation row corresponding to the data word and the current state of the source data from the modulation table; and
outputting the final code word and the next state in response to the modulation row.

7. The method of claim 6, wherein outputting the next state includes outputting the next state as 2 when the lowest 2 bits of the modulation code word of the modulation row is 00, outputs the next state as 0 when the lowest bit of the data word of the source data is 0, and outputs the next state as 1 when the lowest bit of the data word of the source data is 1.

8. The method of claim 7, wherein outputting the final code word includes:
determining whether the next state of the modulation row is 2 and the value of the data word of the source data is an odd number;
determining whether a merging bit exists in response to the data word of the source data; and
determining whether the DSV control bit exists in response to the DSV position bits of the modulation row and the position of the DSV control bit.

9. The method of claim 8, wherein outputting the final code word includes outputting an exception code word as the final code word when the modulation code word of the modulation row corresponds to the exception code word.

10. The method of claim 1, wherein each of the modulation rows further comprises:
a DSV presence bit illustrating whether the DSV control bit exists.

11. The method of claim 10, wherein the size of the DSV position bits is 2 bits, the size of the row selection bit is 1 bit, and the size of the DSV presence bit is 1 bit.

12. The method of claim 1, wherein the optical disk recording/reproducing apparatus is an HD-DVD.

13. A memory unit comprising:
a modulation table including
a plurality of modulation rows, each of the plurality of modulation rows further including a plurality of modulation code word bits indicating a modulation code word;
digital sum value (DSV) position bits indicating a position of DSV control bit; and
a row selection bit indicating whether each of the modulation rows corresponds to an odd data word of source data or an even data word of the source data.

14. An apparatus for modulating the source data, in an optical disk recording/reproducing apparatus, the apparatus comprising:
the memory unit of claim 13; and
a modulator that outputs modulation data by modulating the source data using the modulation table.

15. The apparatus of claim 14, wherein the modulator outputs a final code word and a next state in response to the data word and a current state of the source data from the modulation table and modulates the source data using the final code word and the next state.

16. The apparatus of claim 15, wherein the modulator includes:
a modulation control unit that outputs the modulation row corresponding to the data word and the current state of the source data from the modulation table and outputs the final code word and the next state in response to the modulation row; and
a modulation data output unit that outputs modulation data by modulating the source data in response to the final code word and the next state.

17. The apparatus of claim 16, wherein the modulation control unit includes:
a next state determining logic that outputs the next state in response to the modulation code word of the modulation row and the data word of the source data; and
a final code word determining logic that outputs the final code word in response to the next state and the modulation row.

18. The apparatus of claim 17, wherein the next state determining logic outputs the next state as 2 when the lowest 2 bits of the modulation code word of the modulation row are 00, outputs the next state as 0 when the lowest bit of the data word of the source data is 0, and outputs the next state as 1 when the lowest bit of the data word of the source data is 1.

19. The apparatus of claim 17, wherein the final code word determining logic determines whether the next state of the modulation row is 2 and the value of the data word of the source data is an odd number, determines whether a merging bit exists in response to the data word of the source data, and determines whether a DSV control bit exists in response to the DSV position bits of the modulation row and the position of the DSV control bit.

20. The apparatus of claim 19, wherein the final code word determining logic outputs an exception code word as the final code word when the modulation code word of the modulation row corresponds to the exception code word.

21. The apparatus of claim 13, wherein the modulation table includes a plurality of sub-tables corresponding to a current state of the source data, wherein each of the plurality of sub-tables comprises the plurality of modulation rows according to the current state of the source data.

22. The apparatus of claim 21, wherein the sub-tables are classified as first sub-tables when the current state is 0, and second sub-tables when the current state is 1 or 2.

23. The apparatus of claim 13, wherein each of the modulation rows further comprises:
a DSV presence bit illustrating whether the DSV control bit exists.

24. The apparatus claim 23, wherein the size of the DSV position bits is 2 bits, the size of the row selection bit is 1 bit, and the size of the DSV presence bit is 1 bit.

25. The apparatus of claim 14, wherein the optical disk recording/reproducing apparatus is an HD-DVD.
